(19) United States
(12) Patent Application Publication
(10) Pub. No.: US 2018/0134226 A1
(43) Pub. Date: May 17, 2018

(54) VEHICLE LUGGAGE RACK

(71) Applicant: Ford Global Technologies, LLC, Dearborn, MI (US)

(72) Inventors: Paul Kenneth Dellock, Northville, MI (US); Stuart C. Salter, White Lake, MI (US); Harry Lobo, Canton, MI (US); Michael A. Musleh, Canton, MI (US); Talat Karmo, Waterford, MI (US)

(73) Assignee: For Global Technologies, LLC

(21) Appl. No.: 15/353,845

(22) Filed: Nov. 17, 2016

(51) Int. Cl. B60R 9/04; C25D 7/00; C25D 5/56; B29C 47/00; B29C 47/06

(52) U.S. Cl. CPC B60R 9/04; C25D 7/00; C25D 5/56; B29K 2105/10; B29C 47/065; B29C 47/0066; B29C 47/0004

(57) ABSTRACT

A vehicle luggage rack rail includes a skin layer including a first polymeric material and defining interior and exterior surfaces. A coating is positioned on the exterior surface of the skin layer. A base layer is coupled to the interior surface and includes a second polymeric material. The base layer defines a void therein and a plurality of fibers extending through the base layer.

### FIELD OF THE INVENTION

The present disclosure generally relates to vehicle luggage racks, and more particularly, to vehicle luggage racks employing a composite structure.

### BACKGROUND OF THE INVENTION

Weight savings in vehicles may increase the fuel economy of a vehicle as well as reduce emissions. It is therefore desirable to reduce the weight of vehicle components.

### SUMMARY OF THE INVENTION

According to one aspect of the present disclosure, a vehicle luggage rack rail includes a skin layer including a first polymeric material and defining interior and exterior surfaces. A coating is positioned on the exterior surface of the skin layer. A base layer is coupled to the interior surface and includes a second polymeric material. The base layer defines a void therein and a plurality of fibers extending through the base layer.

According to another aspect of the present disclosure, a method of forming a vehicle luggage rack rail including the steps: extruding a plurality of basalt fiber rovings within a first polymeric material to form a base layer, wherein the rovings are positioned within corners of the base layer; extruding the base layer within a second polymeric material to form a skin layer over the base layer; and plating a metal coating onto an exterior surface of the skin layer.

According to yet another aspect of the present disclosure, a method of forming a vehicle luggage rack rail, including the steps: extruding a plurality of basalt fibers within a first polymeric material to form a base layer, wherein the basalt fibers are substantially concentrated within corners of the base layer; extruding the base layer within a second polymeric material to form a skin layer over the base layer; and cutting the base layer and skin layer to form the rail.

These and other aspects, objects, and features of the present invention will be understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 is a perspective view of a vehicle, according to one example;

FIG. 2A is a cross-sectional view of a luggage rack taken at line IIA of FIG. 1, according to one example;

FIG. 2B is a cross-sectional view of a luggage rack taken at line IIB of FIG. 1, according to one example; and

FIG. 3 is a flow diagram of a method of forming the luggage rack, according to one example.

### DETAILED DESCRIPTION OF THE PREFERRED EMBODIMENT

Additional features and advantages of the invention will be set forth in the detailed description which follows and will be apparent to those skilled in the art from the description or recognized by practicing the invention as described in the following description together with the claims and appended drawings.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

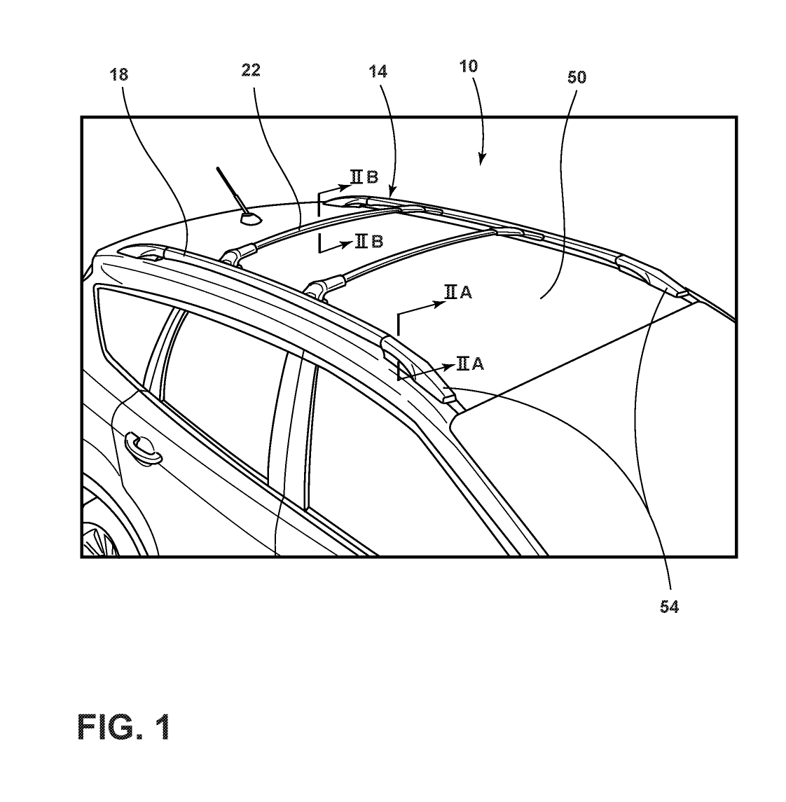

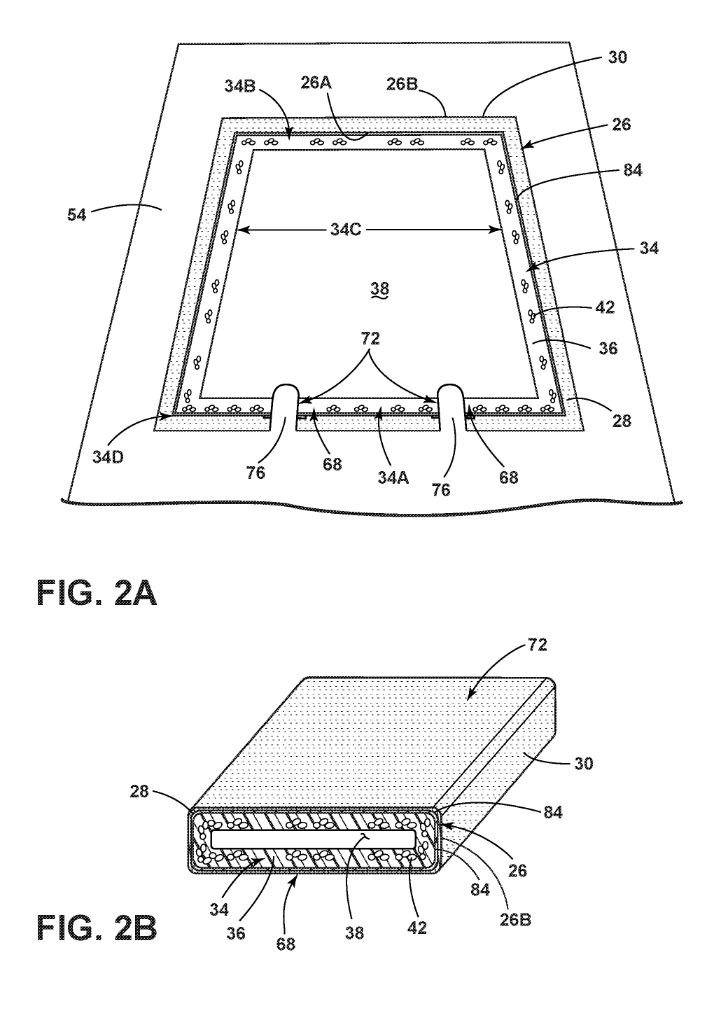

Referring to FIGS. 1-2B, reference numeral 10 generally designates a vehicle having a luggage rack 14. The luggage rack 14 includes a pair of side rails 18 and a plurality of cross rails 22. The side rails 18 and the cross rails 22 include a skin layer 26 defining an interior surface 26A and an exterior surface 26B. The skin layer 26 may include a first polymeric material 28. According to various examples, a metal coating 30 is positioned on the exterior surface 26B of the skin layer 26. A base layer 34 is coupled to the interior surface 26A. The base layer 34 may include a second polymeric material 36. The base layer 34 defines a void 38 therein. According to various examples, the base layer 34 may include a plurality of fibers extending though the base layer 34 as fiber rovings 42.

Referring now to FIG. 1, the vehicle 10 is depicted as a sport utility vehicle, but it will be understood that the vehicle 10 may also be a van, truck, sedan, crossover vehicle, or other types of vehicles 10 incorporating luggage racks. The luggage rack 14 is positioned on a roof 50 of the vehicle 10. It will be understood that the description below of the luggage rack 14 may equally be applied to other racks positioned on and around the vehicle 10. For example, the description of the luggage rack 14 may equally be applied to a tire rack positioned on a rear of the vehicle 10, as well as to racks as well as to other racks positioned around an exterior and/or interior of the vehicle 10. The luggage rack 14 is coupled to the roof 50 through attachment points 54. In the depicted example, the luggage rack 14 is coupled to the roof 50 with four attachment points 54, but it will be understood that the luggage rack 14 may include less than four attachment points (e.g., three attachment points 54) or greater than four attachment points 54 (e.g., five or more attachment points). The attachment points 54 may be bolted to the roof 50 such that the luggage rack 14 does not move when loaded with cargo. The luggage rack 14 includes both the side rails 18 and cross rails 22. The side rails 18 extend between the attachment points 54 and the cross rails 22 extend between the side rails 18. The side rails 18 may extend into the attachment points 54 such that ends of the side rails 18 are covered and/or surrounded by the attachment points 54. In the depicted example, the side rails 18 extend between two attachment points 54, but it will be understood more attachment points 54 may be positioned along the length of the side rails 18 for greater stability. Further, one or more of the cross rails 22 may include an attachment point 54 for greater stability. In the depicted example, the side rails 18 extend in a lengthwise direction along the vehicle (i.e., in vehicle forward and rearward directions) but may additionally or alternatively extend from a passenger side to a driver side of the vehicle 10. In such an example, the cross rails 22 may extend in the vehicle forward and rearward directions. Further, in the depicted example, the side rails 18 extend above the roof 50, but may additionally or alternatively extend in contact with the roof 50 of the vehicle 10. The side rails 18 may define a curvature or sweep over the length of the side rails 18. As explained above, the cross rails 22 extend between the side rails 18. In the depicted example, a plurality of cross rails 22 extend between the side rails 18, but it will be understood that a single cross rail 22 may extend between the side rails 18. Similarly to the side rails 18, the cross rail 22 may define a curvature or sweep extending away from the roof 50 of the vehicle 10.

Referring now to FIGS. 2A and 2B, both the side rails 18 and the cross rails 22 include the base layer 34. The base layer 34 defines a base 34A, a top 34B, sides 34C and corners 34D. The base 34 may be composed of a polymer, a metal, a ceramic, combination thereof. In polymeric examples of the base 34, the base may include the second polymeric material 36 and a plurality of fibers bundled as the fiber rovings 42. The second polymeric material 36 may include a nylon, a polypropylene, an epoxy, a polyester, a vinyl ester, a polyetheretherketone, a poly(phenylene sulfide), a polyetherimide, a polycarbonate, a silicone, a polyimide, a poly(ether sulfone), a melamine-formaldehyde, a phenol-formaldehyde, and a polybenzimidazole, or combinations thereof. The fibers of the fiber rovings 42 may include carbons, aramids, aluminum metals, aluminum oxides, steels, borons, silicas, silicon carbides, silicon nitrides, ultra-high-molecular-weight polyethylenes, A-glasses, E-glasses, E-CR-glasses, C glasses, D-glasses, R-glasses, S-glasses, basalt and combinations thereof. In basalt examples of the fibers, the basalt fibers may have a diameter of between about 1 μm and about 40 μm, or between about 10 μm and about 30 μm, or between about 13 μm and about 20 μm. The pluralities of fibers are bundled as the fiber rovings 42 and extend through the rails 18, 22. A fiber roving 42 may be a long and narrow bundle of fibers. The fibers of the rovings 42 may be twisted, knotted, bonded (e.g., with an adhesive), or otherwise coupled to form a long, continuous bundle of the fibers. The rovings 42 may be a single, continuous, fiber bent back and forth on itself, or a plurality of fibers bundled together. In examples of the rovings 42 having a plurality of fibers, the fibers may have substantially the same composition (e.g., all fibers are composed of basalt). In other examples, the rovings 42 may be formed of a plurality of fibers with different compositions. In such examples, the rovings 42 may have a basalt composition (i.e., a percentage of the fibers including basalt) of greater than or equal to about 5%, 10%, 20%, 30%, 40%, 50%, 60%, 70%, 80%, 90% or great than or equal to about 99%. Further, different rovings 42 may have different compositions (e.g., some rovings 42 are all basalt and some are rovings 42 are all carbon fiber and/or different rovings 42 have different basalt compositions).

The fiber rovings 42 may extend a majority of the length of the rails 18, 22 or only a portion of the rails 18, 22. In other examples, the fiber rovings 42 extend through an entire length of the rails, 18, 22. It will be understood that a portion of the rovings 42 may be continuous and a portion of the rovings 42 may be discontinuous. The fiber rovings 42 may be aligned along the length (e.g., in the vehicle forward and rearward directions) of the rails 18, 22. In examples where the rovings 42 are discontinuous across the rails 18, 22, the rovings 42 may be aligned with one another (e.g., substantially co-axially). According to various examples, the fiber rovings 42 may be positioned within high stress areas (e.g., high tension stress areas) of the side rails 18 and the cross rails 22. Such high stress areas may include the corners 34D, the base 34A and other high stress areas. The fiber rovings 42 may be positioned in the high stress areas such that a greater proportion of the fiber rovings 42 are positioned in the corners 34D of the rails 18, 22 relative the sides 34C or the top 34B of the base layer 34. It will be understood that a greater number of rovings 42 may be positioned at high stress areas along the length of the rails 18, 22 (i.e., in a three-dimensional manner rather than just a two-dimensional manner). For example, the center of the rails 18, 22 (e.g., as measured from end to end of the rails 18, 22) may have a greater number of rovings 42 (e.g., anywhere in the base layer 34) as compared to ends of the rails 18, 22. Further, the fiber rovings 42 may be positioned on an inboard or an outboard side of the base layer 34 depending on anticipated stresses to be experienced by the luggage rack 14 in use. The rovings 42 may have a fiber volume fraction in the second polymeric material 36 of greater than or equal to about 1%, 5%, 10%, 20%, 30%, 40%, 50%, 60%, 70%, 80% or greater than or equal to about 90%. It will be understood that the second polymeric material 36 may include a plurality of chopped fibers, either aligned or unaligned, disposed through the base layer 34 of the side rails 18 and the cross rails 22.

The base layer 34 defines the void 38 extending therethrough. The void 38 may account for a cross-sectional area of the base layer 34 of greater than or equal to about 5%, 10%, 20%, 30%, 40%, 50%, 60%, 70%, and 80%. The void 38 may have a cross-sectional shape substantially similar to that of the base layer 34, or may be different. For example, the void 38 may be square, rectangular, circular, star pattern or other cross-sectional two-dimensional shapes. According to some examples, the void 38 may extend a majority of a length of the rails 18, 22. In other examples, the void 38 may extend an entire length of the rails 18, 22 or may be a segmented or discontinuous structure. In some examples, one or more support ribs may extend across the void 38. The fiber rovings 42 may be positioned in the base layer 34 to define retention zones 68 where substantially no fiber rovings 42 exist. The retention zones 68 may be defined in both the base 34A and the sides 34C of the base layer 34. The base layer 34 and the skin layer 26 cooperate to define one or more retention features 72. The retention features 72 are configured to accept attachment features 76. The attachment features 76 and retention features 72 cooperate to couple the side rails 18 to the attachment points 54. It will be understood, that the retention features 72 and the attachment features 76 may also couple the side rails 18 to the cross rails 22 in a substantially similar manner. The retention features 72 are defined within the retention zones 68 so as not to interfere with the fiber rovings 42. In other examples, the attachment features 76 may directly couple with the rovings 42 to enhance rigidity of the luggage rack 14.

Positioned between the base layer 34 and the interior surface 26A of the skin layer 26 is an optional tie layer 84. The tie layer 84 may be an adhesive or polymeric material which is compatible with the first and second polymeric materials 28, 36. The tie layer 84 may be used to create greater adhesion between the skin layer 26 and the base layer 34. Additionally or alternatively, mechanical methods (e.g., surface roughening, fasteners, mechanical coupling mechanisms, etc.) may be used to create greater adhesion between the skin layer 26 and the base layer 34.

The skin layer 26 may be composed of a polymeric material, a metal, a ceramic material or combinations thereof. In polymeric examples, the skin layer 26 may be formed of the first polymeric material 28. The first polymeric material 28 may be composed of a nylon, a polypropylene, an epoxy, a polyester, a vinyl ester, a polyetheretherketone, a poly(phenylene sulfide), a polyetherimide, a polycarbonate, a silicone, a polyimide, a poly(ether sulfone), a melamine-formaldehyde, a phenol-formaldehyde, and a polybenzimidazole, acrylonitrile butadiene styrene or combinations thereof. According to some examples, the skin layer 26 may not include the fiber rovings 42 or chopped fibers disposed therein. In yet other examples, the skin layer 26 may include the fiber rovings 42 and/or chopped fibers.

According to various examples, the skin layer 26 may be amenable to plating, painting, printing or combinations thereof. The coating 30 is positioned on the exterior surface 26B of the skin layer 26. The coating 30 may be a paint layer, a decorative layer, or a plated layer. For example, the plated layer may include a metal which has been electrically plated (e.g., through electro-deposition) to the skin layer 26. In decorative layer examples of the coating 30, the decorative layer may be adhesively, chemically, or mechanically bonded to the exterior surface 26B of the skin layer 26. The decorative layer may provide a metallic appearance, a colored appearance, a textured appearance (e.g., wood, brushed metal, etc.) alphanumeric text, and combinations thereof to the luggage rack 14.

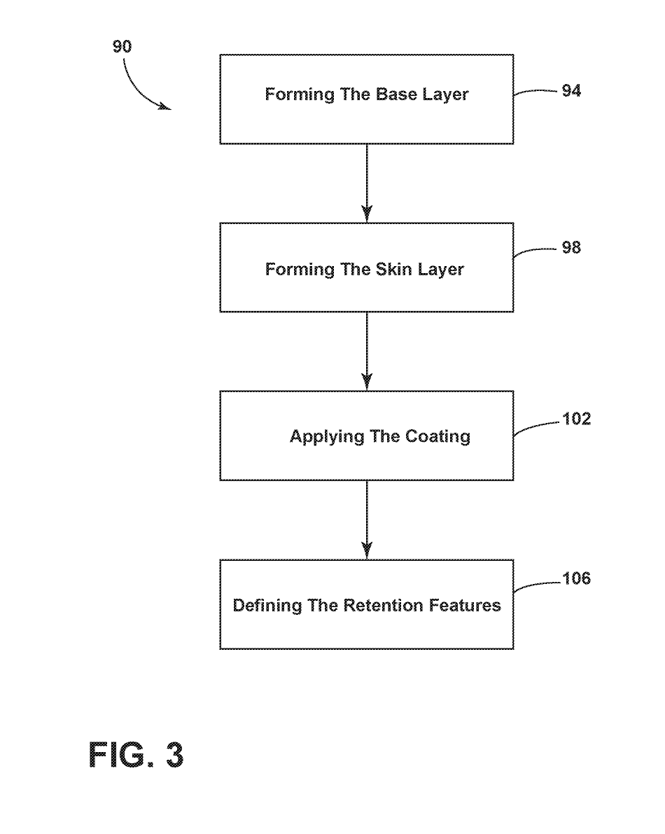

Referring now to FIG. 3 depicted is an exemplary method 90 of forming the side rail 18 and/or the cross rails 22. The method 90 begins with step 94 of extruding a plurality of the fiber rovings 42 within the second polymeric material 36 to form the base layer 34. Such a process may be known as pultrusion. Pultrusion is a continuous molding process whereby reinforcing fibers (e.g., the rovings 42) are saturated with a liquid polymer resin (e.g., the second polymeric material 36) and then carefully formed and pulled through a heated die to form a part (e.g., the rails 18, 22). As the rovings 42 and the second polymeric material 36 are pulled through a heated die, the second polymeric material 36 undergoes polymerization. The die may be stationary or move dynamically. The impregnation is either done by pulling the rovings 42 through a bath or by injecting the second polymeric material 36 into an injection chamber which may be connected to the die. The fiber rovings 42 may be bundled basalt fibers and the second polymeric material 36 may be nylon. In step 94, the fiber rovings 42 are positioned to define the retention zones 68 within the base layer 34 such that the retention zones 68 are substantially free of the fiber rovings 42. Further, the rovings 42 may be positioned with a greater concentration in the expected high stress zones (e.g., the base 34A and/or the corners 34D) as explained above.

Next, a step 98 of extruding the base layer 34 within the second polymeric material 36 to form the skin layer 26 over the base layer 34 is performed. In such an example, the first polymeric material 28 may be of a composition amenable to painting, or electrical plating. The first polymeric material 28 may be applied to the base layer 34 immediately after formation of the base layer 34, or at a later point in production.

Next, a step 102 of applying the coating 30 to the exterior surface 26B of the skin layer 26 is performed. In such a step, applying the coating 30 may include applying the decorative layer, painting the exterior surface 26B, and/or plating a metal layer onto the exterior surface 26B of the skin layer 26. Electroplating may be a process that uses electric current to reduce dissolved metal cations so that they form a thin coherent metal coating on an electrode (e.g., the skin layer 26).

Next, step 106 of defining the retention features 72 within the retention zones 68 is performed. The retention features 72 may be formed via drilling holes, or heat staking the attachment features 76 into the retention zones 68. It will be understood that the steps of the method 90 disclosed herein may be performed in any order or may be performed at the same time as any other step without departing from the teachings provided herein.

Use of the present disclosure may offer several advantages. First, constructing the luggage rack 14 of low cost and low density materials may provide a weight reduction to the vehicle 10 at a significantly lower cost than conventional materials. Second, by applying the coating 30 to the exterior surface 26B, additional manufacturing steps such as polishing may not be required, which may save both manufacturing time and expense. Third, by utilizing the skin layer 26 over the base layer 34, structural polymeric materials which may typically not be able to provide a decorative appearance may be utilized (e.g., as the base layer 34) while still offering an aesthetically pleasing design. Fourth, use of the skin layer 26 may offer multiple appearances and finishes across the different components of the luggage rack 14 which may offer a design flexibility. Fifth, use of basalt fibers in the rovings 42 instead of traditional fibers, such as carbon fibers, may result in a cost savings while achieving the same or comparable mechanical strength.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise. Further, the claims as set forth below, are incorporated into and constitute part of this Detailed Description.

What is claimed is:

1. A vehicle luggage rack rail, comprising:
a skin layer comprising a first polymeric material and defining interior and exterior surfaces;
a coating positioned on the exterior surface of the skin layer;
a base layer coupled to the interior surface and comprising a second polymeric material, wherein the base layer defines a void therein; and
a plurality of fibers extending through the base layer.

2. The rail of claim 1, wherein the void extends a majority of a length of the rail.

3. The rail of claim 2, wherein the coating comprises at least one of paint and a metal.

4. The rail of claim 3, wherein the plurality of fibers are bundled as rovings extending through the rail.

5. The rail of claim 4, wherein the rovings extend a majority of the length of the rail.

6. The rail of claim 5, wherein a greater proportion of rovings are positioned in corners of the rail relative to sides of the rail.

7. The rail of claim 6, wherein the base layer defines retention zones with no rovings, the base layer defining retention features within the retention zones.

8. The rail of claim 7, wherein the polymeric material of the base layer and the polymeric material of the skin layer have different compositions.

9. The rail of claim 8, wherein the first polymeric material comprises nylon and the second polymeric material comprises acrylonitrile butadiene styrene.

10. The rail of claim 9, wherein the rail is a side rail of the vehicle luggage rack.

11. The rail of claim 9, wherein the rail is a cross rail of the vehicle luggage rack.

12. A method of forming a vehicle luggage rack rail, comprising the steps:
extruding a plurality of basalt fiber rovings within a first polymeric material to form a base layer, wherein the rovings are positioned within corners of the base layer;
extruding the base layer within a second polymeric material to form a skin layer over the base layer; and
plating a metal coating onto an exterior surface of the skin layer.

13. The method of claim 12, wherein the base layer defines a void therein extending the length of the rail.

14. The method of claim 13, further comprising the step of:
positioning the rovings to defining retention zones within the base layer that are substantially free of the rovings.

15. The method of claim 14, further comprising the step of:
defining retention features within the retention zones.

16. A method of forming a vehicle luggage rack rail, comprising the steps:
extruding a plurality of basalt fibers within a first polymeric material to form a base layer, wherein the basalt fibers are substantially concentrated within corners of the base layer;
extruding the base layer within a second polymeric material to form a skin layer over the base layer; and
cutting the base layer and skin layer to form the rail.

17. The method of claim 16, wherein the basalt fibers are bundled as rovings.

18. The method of claim 17, further comprising the step of:
positioning the rovings within corners defined by the base layer.

19. The method of claim 18, further comprising the step of:
plating a metal coating onto an exterior surface of the skin layer.

20. The method of claim 19, further comprising the step of:
positioning the rovings to defining retention zones within the base layer that are substantially free of the rovings.
